(19) United States
(12) Patent Application Publication
(10) Pub. No.: US 2010/0086303 A1
(43) Pub. Date: Apr. 8, 2010

(54) HIGH SPEED POLMUX-OFDM USING DUAL-POLMUX CARRIERS AND DIRECT DETECTION

(75) Inventors: Dayou QIAN, PRINCETON, NJ (US); Neda CVIJETIC, PRINCETON, NJ (US); Yue-Kai HUANG, PRINCETON, NJ (US); Jianjun YU, PRINCETON, NJ (US); Ting WANG, PRINCETON, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA INC, PRINCETON, NJ (US)

(21) Appl. No.: 12/571,484

(22) Filed: Oct. 1, 2009

Related U.S. Application Data
(60) Provisional application No. 61/102,146, filed on Oct. 2, 2008.
(60) Provisional application No. 61/102,150, filed on Oct. 2, 2008.

(51) Int. Cl. H04L 27/28; H04J 14/06

(52) U.S. Cl. 398/65; 375/260

(57) ABSTRACT

A polarization multiplexing, orthogonal frequency division multiplexing (POMUX) transmission system utilizing direct detection.

### CROSS-REFERENCE TO RELATED APPLICATION

This application claims the benefit of U.S. Provisional Patent Application Ser. Nos. 61/102,146 and 61/102,150 filed Oct. 2, 2008 which are incorporated by reference as if set forth at length herein.

### FIELD OF DISCLOSURE

This disclosure relates generally to the field of telecommunications and in particular to an architecture employing polarization multiplexing of orthogonal frequency division multiplexed transmissions and direct detection of same.

### BACKGROUND OF DISCLOSURE

Fueled in part by the growing demand for broadband services, the transport capacity of next-generation optical access/metro networks is migrating to 40-Gb/s or 100-Gb/s. However, unlike long-haul networks whose distance-bandwidth product is large enough to justify high implementation costs, access/metro networks (<600 Km) must manage hardware and operational costs/complexity in order to remain attractive and practical.

It is known that in 40/100-Gb/s optical links, fiber dispersion may severely limit transmission distances. Orthogonal Frequency Division Multiplexing (OFDM) has been shown to be useful for high-speed optical transmission due—in part—to both a high resistance to fiber dispersion (both CD and PMD) and high spectral efficiency. By thus reducing or eliminating altogether the need for dispersion compensation and reducing the transmission bandwidth (OFDM) can significantly increase the flexibility of metro and access optical networks while reducing implementation costs. Additionally, polarization multiplexing (POLMUX), wherein a high-speed OFDM signal is carried in two orthogonal polarizations, has been proposed in long-haul OFDM transmission as a spectrally-efficient alternative to generating very high-speed signals. The trade-offs in such multiple-input multiple-output (MIMO) POLMUX-OFDM systems is the need for coherent detection which entails an additional narrow linewidth laser as a local oscillator at the receiver and complex frequency-offset and phase noise compensation algorithms that may be too costly for access/metro networks.

### SUMMARY OF DISCLOSURE

An advance is made in the art according to the principles of the present disclosure directed to a POLMUX-OFDM 40/100-Gb/s transmission architecture employing direct detection.

In sharp contrast to prior art systems and architectures, systems constructed according to the present disclosure employ two OFDM signals which are combined by a polarization beam combiner (PBC) at a central office (CO), split at a receiver by a polarization beam splitter PBS) and direct-detected by two photo-diodes—for example.

Advantageously, a direct-detection polarization multiplexing system according to the present disclosure provides significantly lower cost as compared with polarization-multiplexing using coherent detection while exhibiting the same spectrum efficiency.

### BRIEF DESCRIPTION OF THE DRAWING

A more complete understanding of the disclosure may be realized by reference to the accompanying drawing in which:

FIG. 1(A) and FIG. 1(B) is a schematic of a transmitter and receiver respectively for a POLMUX OFDM Transmission System with coherent detection;

FIG. 2 is a schematic of an optical hybrid employing both phase and polarization diversities according to an aspect of the present disclosure;

FIG. 3 is a schematic of a POLMUX-OFDM transmission system with dual-POLMUX-Carriers and direct detection according to an aspect of the present disclosure;

FIG. 4 is a schematic of a dual-POLMUX transmitter according to an aspect of the present disclosure;

FIG. 5 is a series of illustrations depicting the steps in a dual-POLMUX carrier transmission;

FIG. 6 is simplified schematic of an OFDM receiver according to an aspect of the present disclosure;

FIG. 7 is a simplified schematic of a MIMO POLDEMUX Receiver according to an aspect of the present disclosure;

FIG. 8 shows training patters—option 1;

FIG. 9 shows training patterns—option 2;

FIG. 10 shows training and data signal assessment on both polarization X and Y according to an aspect of the present invention;

FIG. 11 shows received signals of the training pattern option 1 on two polarizations X′ and Y′; and

FIG. 12 shows received signals of the training pattern option 2 on two polarizations X′ and Y′.

### DESCRIPTION OF EMBODIMENTS

The following merely illustrates the principles of the various embodiments. It will thus be appreciated that those skilled in the art will be able to devise various arrangements which, although not explicitly described or shown herein, embody the principles of the embodiments and are included within their spirit and scope.

Furthermore, all examples and conditional language recited herein are principally intended expressly to be only for pedagogical purposes to aid the reader in understanding the principles of the embodiments and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures depicting the principles of the embodiments.

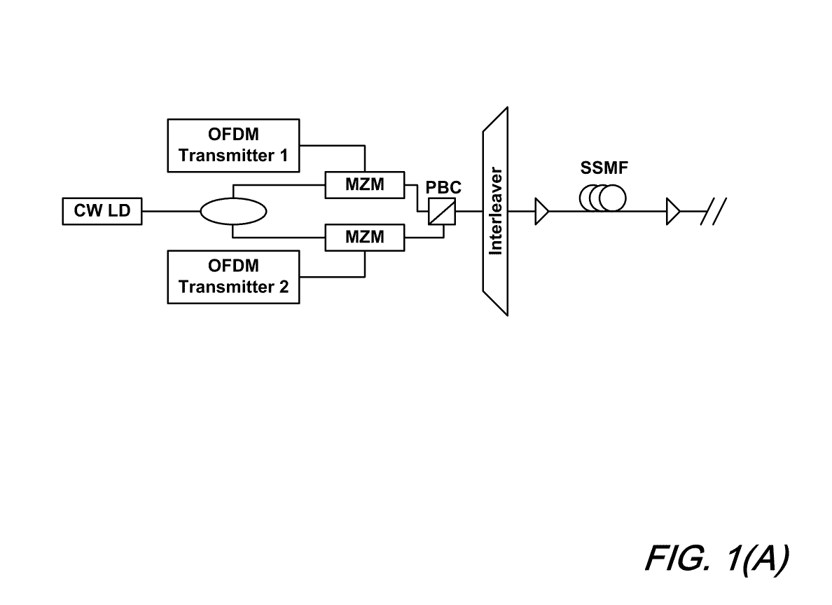

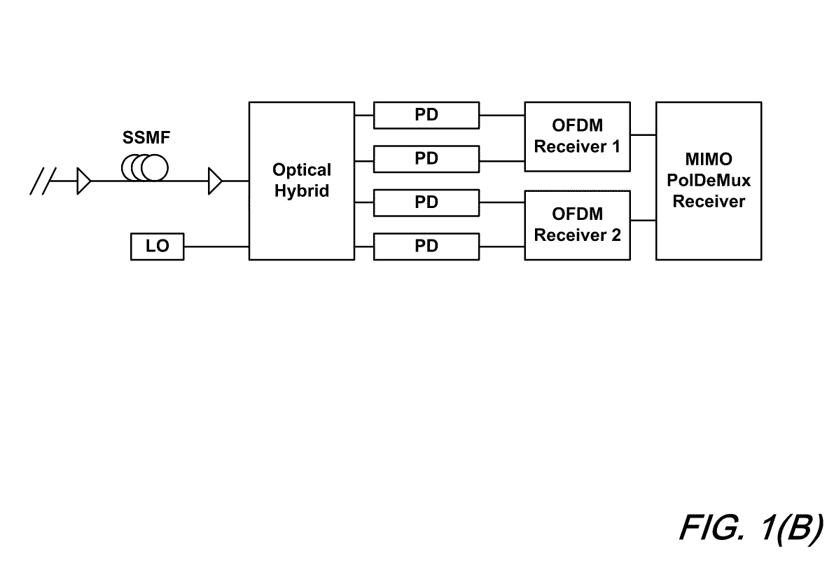

FIG. 1 shows a conventional POLMUX-OFDM system with coherent detection. As shown in that figure, two OFDM signals are separately generated by two modulators and subsequently combined through the effect of a polarization beam combiner (PBC) thereby forming a POLMUX-OFDM signal. An interleaver—positioned after the PBC—filters out a signal sideband to avoid severe chromatic dispersion (CD).

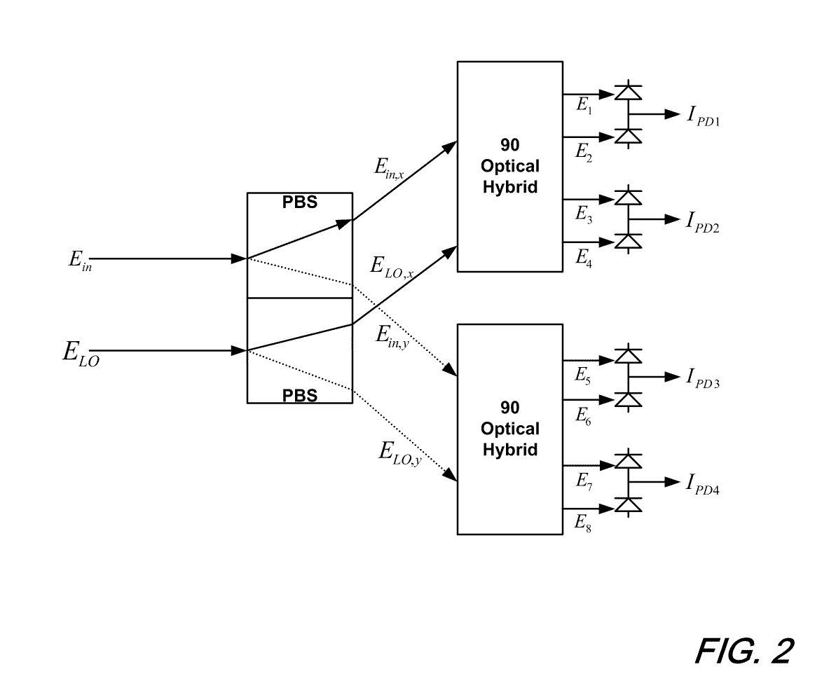

As can be readily appreciated by those skilled in the art, coherent detection is traditionally used for receiving POLMUX-OFDM signals. Consequently, at a receiving end both received POLMUX-OFDM signals and a local oscillator (LO) signal are processed jointly by an optical hybrid, which is generally known by those skilled in the art as a device that will split the received signal into two separate polarizations and perform an I/Q down-conversion at the same time. More details about the optical hybrid can be found in FIG. 2.

An optical hybrid employing both phase and polarization diversity is shown schematically in FIG. 2. As shown in FIG. 2, the optical hybrid generates 4 outputs which are designated X-I, X-Q, Y-I, Y-Q, where X and Y refers to the two orthogonal polarizations decided by the state of polarization (SOP) of the LO signal, and I and Q are two orthogonal phases. 4 outputs are detected by 4 photo-diodes and received by two regular OFDM receivers. After converting to the electronic frequency domain, the POLMUX OFDM signals are separated by the conventional (MIMO) PolDeMux method.

As can now be readily appreciated by those skilled in the art, apparatus and methods according to the present disclosure will utilize a Dual-PolMux-Carriers transmission method with direct-detection and a particular digital signal processing algorithm to receive the POLMUX-OFDM signals.

Advantageously, methods and systems so constructed that employ a direct-detection in a polarization-multiplexing transmission system, exhibit greatly reduced system complexity and cost as compared with polarization-multiplexing using coherent-detection. In addition, systems and methods according to the present disclosure advantageously maintain a spectrum efficiency equivalent to those of existing systems and methods.

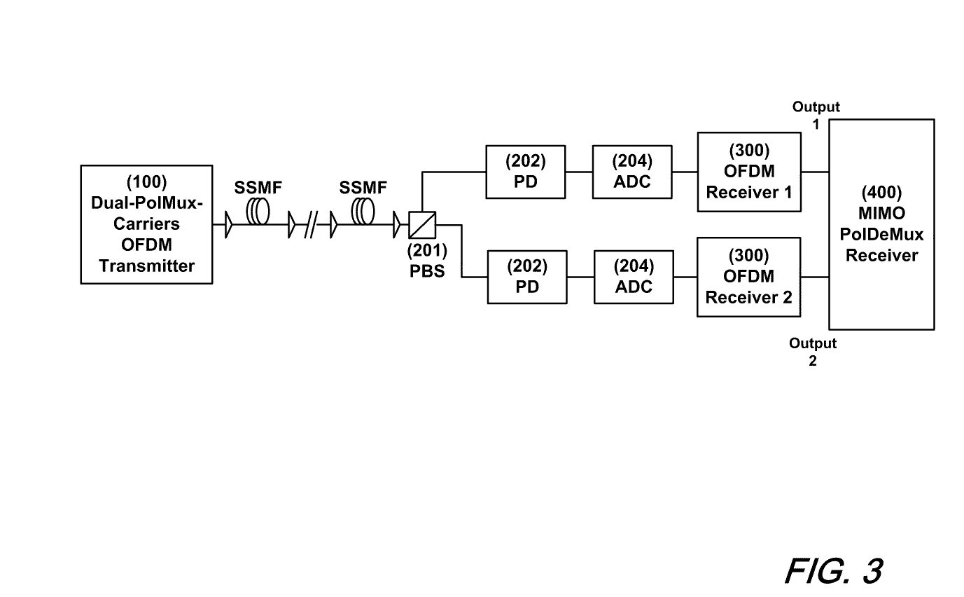

With reference now to FIG. 3, there is shown a schematic block diagram of a POLMUX-OFDM transmission system with Dual-POLMUX Carriers and direct detection according to an aspect of the present disclosure. As shown, a POLMUX-OFDM signal is generated through the effect of dual-POLMUX-Carrier transmitters 100 which is then transmitted via optical fibers which may include one or more amplifiers (e.g., erbium-doped fiber amplifiers—EDFA) to receivers.

At the receiver side of the optical transmission system, the POLMUX-OFDM signal is split through the effect of a polarization-beam-splitter (PBS) 201, and the split signals being subsequently detected by a pair of photo-detectors (e.g., photodiodes) 202, and digitized by analog-to-digital converters (ADC) 204

At this point, those skilled in the art will appreciate that the OFDM signal is still an RF signal at the carrier frequency. Then, the OFDM receiver 300 down-converts the RF OFDM signal to a baseband signal and converted to a digital IQ-Demux substantially simultaneously. The OFDM receivers 300 will output data signals in a frequency domain at which point it is still a mixed signal from both orthogonal polarizations of the transmitter. A MIMO PolDeMUX 400 receiver will recover the data at both polarizations.

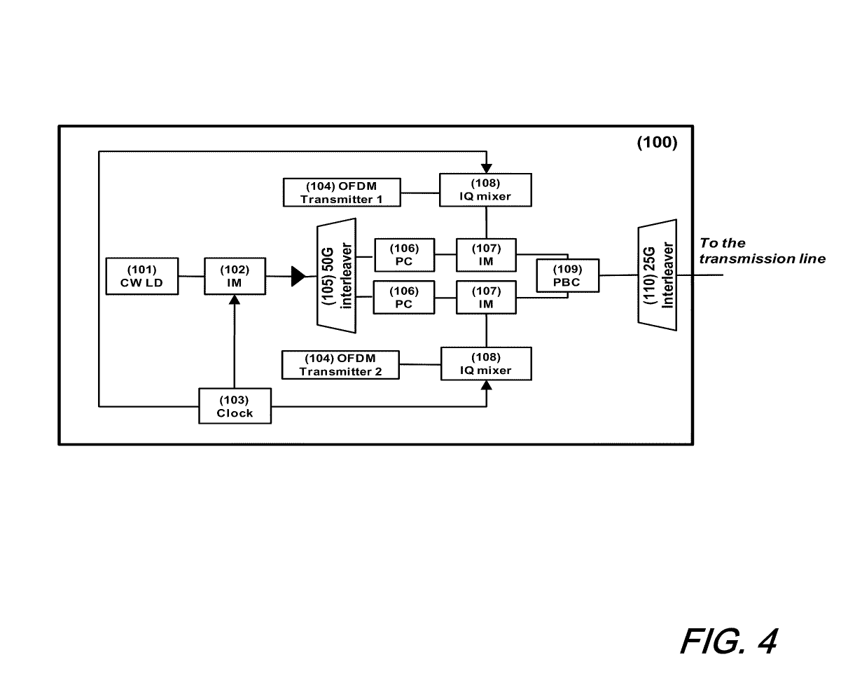

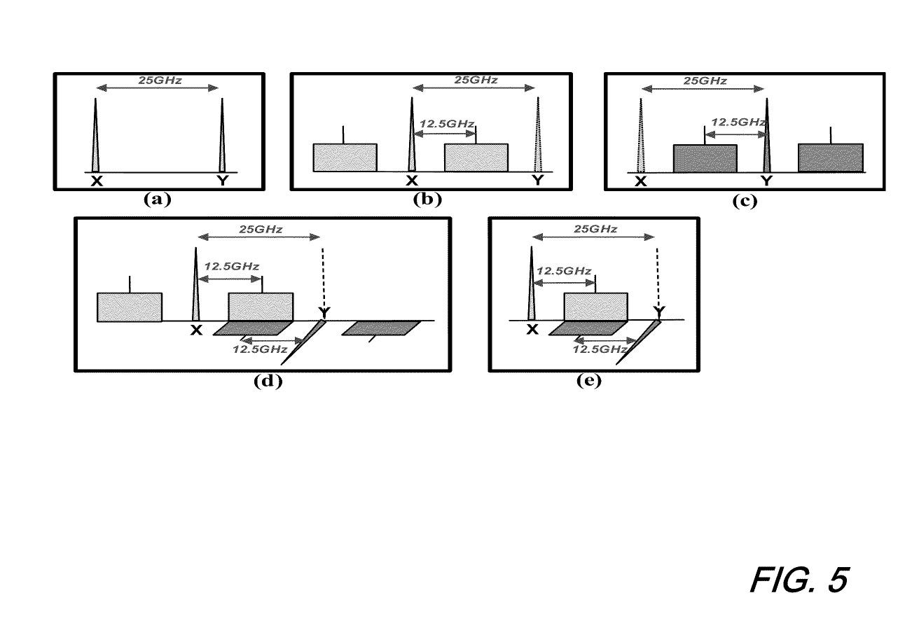

Turning now to FIG. 4, there is shown a schematic of a Dual-POLMUX Transmitter according to an aspect of the present disclosure. More particularly, light emanating from a CW laser 101 is directed through an intensity modulator (IM) 102 which is driven by a clock source 103 with carrier suppression sufficiently such that it generates two optical carriers which are offset from one another by an amount substantially equal to 2× (two times) the clock source frequency. With simultaneous reference now and as exemplary shown in FIG. 5(a), when the clock source is at—for example—12.5 GHz, the two carriers are generated having a 25 GHz separation from one another.

Advantageously, and as can now be readily appreciated, by careful selection of the wavelength output of the CW laser, those two optical carriers can be separated by a 50G optical interleaver 105 with only one carrier on each odd/even output. As shown, the two outputs (carriers) are then modulated by two Intensity Modulators 107 which in turn are driven by RF OFDM signals generated by baseband OFDM transmitter 104 and IQ-mixer 108.

In this preferred embodiment shown in FIG. 4, the radio frequency carrier of the RF OFDM uses the same clock source 103 as that used by the first IM 102. FIGS. 5(b) & 5(c) show the modulated optical OFDM signals after the IM 107. Notably, in FIG. 5, the carriers marked by dotted lines do not physically exist, but are only used as a reference to explain where the modulated OFDM signals are located.

Because the two optical carriers and the RF OFDM signal share the same clock source, the modulated OFDM signal would be exactly located in the middle of those two optical carriers. Additionally, the OFDM signals positioned between those two carriers from both of the intensity modulators 107 will completely overlap each other at the optical spectrum.

Subsequently, the modulated OFDM signals with carriers are combined through the effect of a beam combiner, PBC 109 which generates a POLMUX-OFDM signals having dual-polmux-carriers as shown in FIG. 5(d). Lastly, two side bands are filtered out through the effect of a substantially 25G optical interleaver 110 and the resulting output signal (shown in FIG. 5(e)) is output to a transmission line.

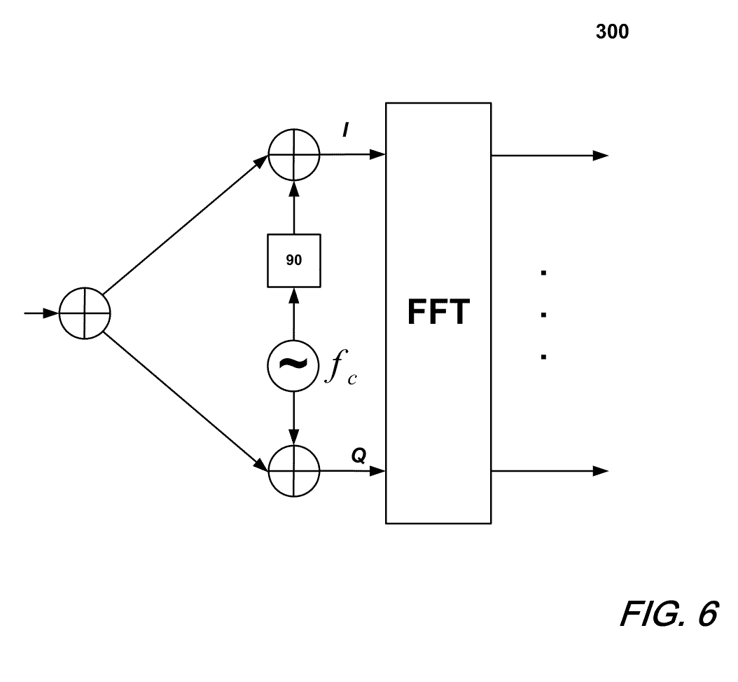

With reference now to FIG. 6 there is shown an OFDM receiver 300 according to an aspect of the present disclosure. As may be appreciated from a review of that FIG. 6, the OFDM receiver 300 may advantageously comprise a digital IQ-demux and an OFDM receiver as shown.

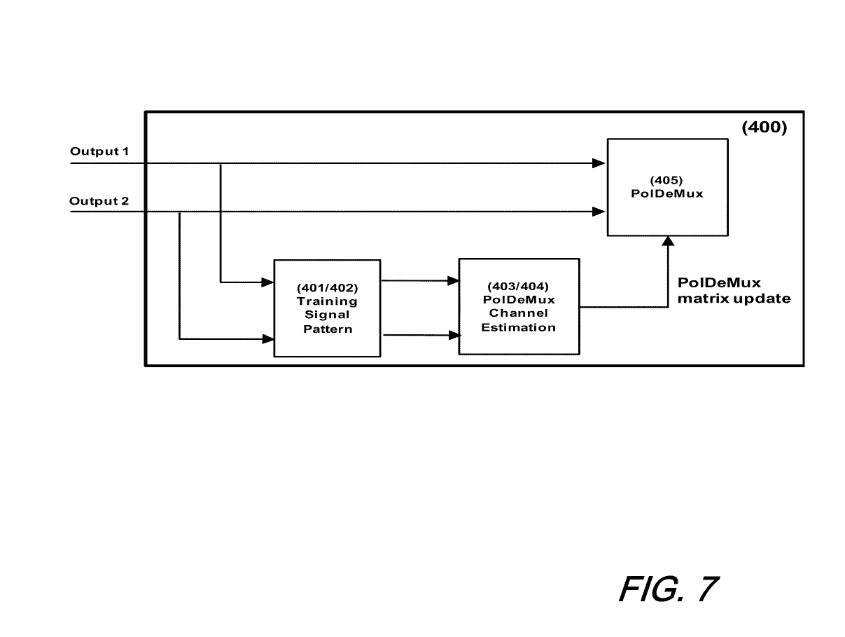

FIG. 7 shows in schematic form a POLMUX receiver according to an aspect of the present disclosure. More particularly, the MIMO PolDeMux receiver 400 shown in FIG. 7 has at least two principal functions. The first function is channel estimation (performed at block 403/404) through training signals (block 401/402). The second function is polarization de-multiplexing (PolDeMux)(performed at block 405) for the POLMUX-OFDM signals based upon channel estimation results. Because the transmitter and the POLMUX-OFDM signals are different from a “conventional” PolMux-OFDM system using coherent receiver, new training signal patterns, channel estimation algorithms and PolDeMux algorithm(s) are required.

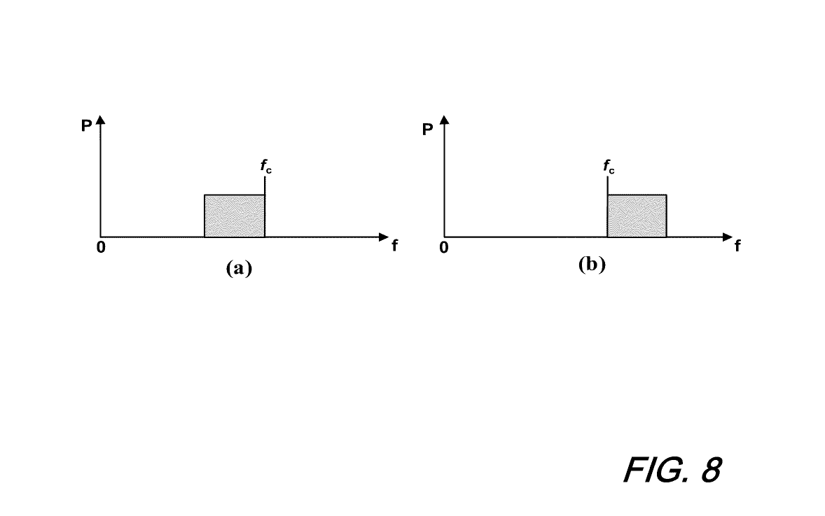

When an IQ-mixer is available, there are two training patterns (Option 1 and 2) available for channel estimation. Training pattern—Option 1—(401) is shown in FIGS. 8(a) and 8(b). It has two different sets which should be sent one after another. Set 1 is an RF OFDM signal with only predefined signals below the IQ carrier (Re{Sᵢ}=0, Im{Sᵢ}=0, if i>N/2, where N is the total FFT size and the Sᵢ is the modulated signal for the i-th sub-carrier.). Training set 2 is above the IQ carrier (Re{Sᵢ}=0, Im{Sᵢ}=0, if i<N/2.).

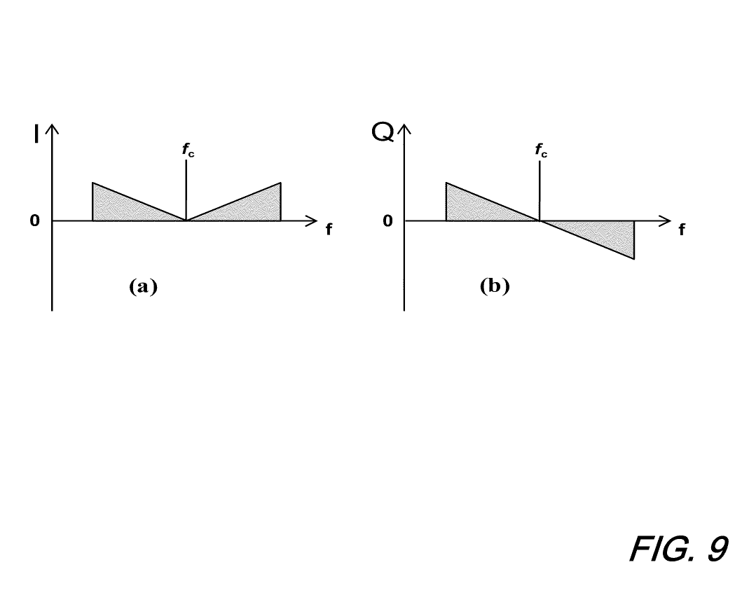

Training pattern (Option 2) (402) is shown in FIG. 9. It also has two sets. The set 1 is designed as Re{Sᵢ}=Re{S_{N-i+1}}, Im{Sᵢ}=0, where N is the total FFT size and the Sᵢ is the modulated signal for the i-th sub-carrier. The set 2 is designed as Im{Sᵢ}=−Im{S_{N-i+1}}, Re{Sᵢ}=0.

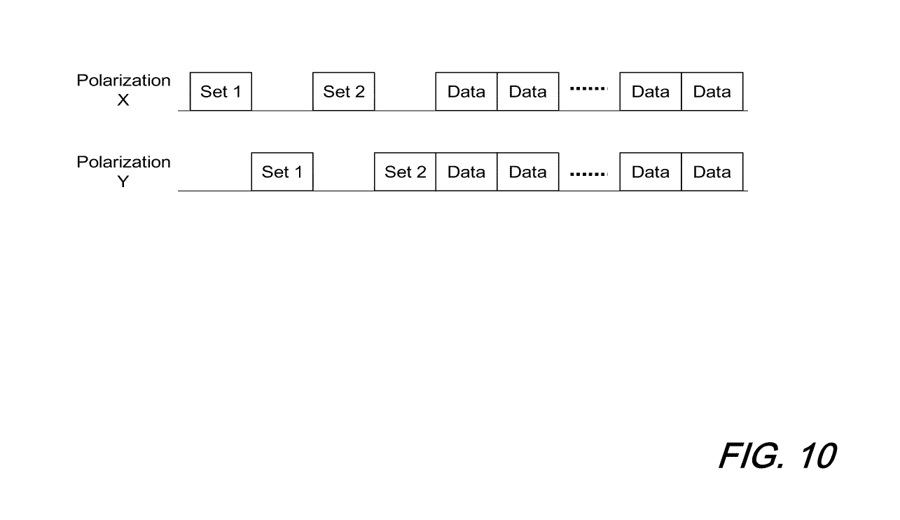

For both training pattern options (block 401/402), the training signals consist of at least one pair of set 1 and set 2 from the training pattern option. The training signals are transmitted on both polarizations non-overlapped as shown in FIG. 10.

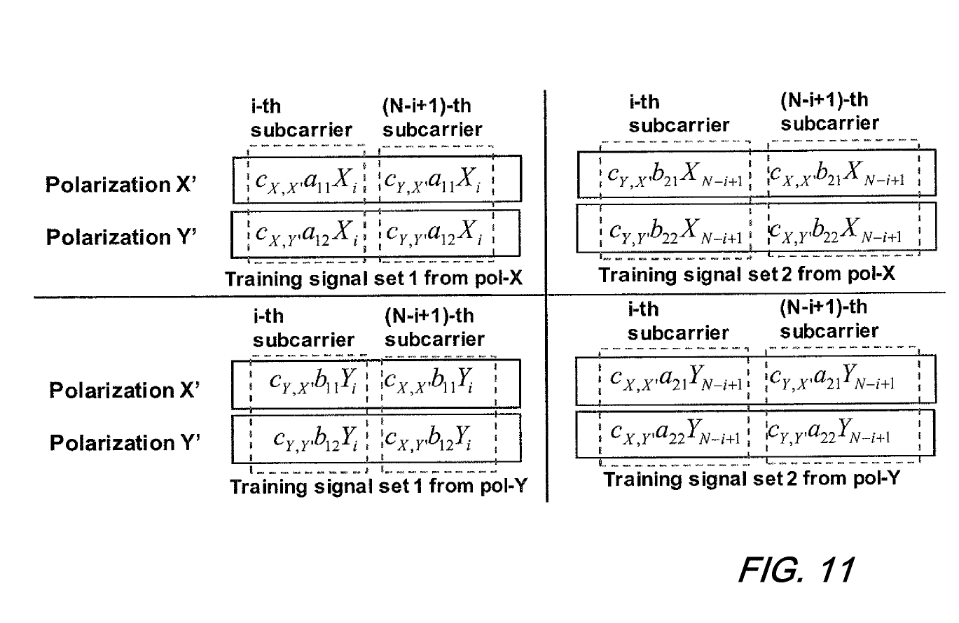

Two training pattern options (block 401, 402) use different channel estimation algorithms (block 403, 404). For training option 1 (block 401), the channel estimation can be directly found by using the output of each sub-carrier after the OFDM receiver (block 300). The output of the OFDM receivers (block 300) can be expressed as shown in FIG. 11.

As can be appreciated by those skilled in the art, coefficients a and b are the power splitting ratio caused by the polarization rotation, and c is the receiving efficiency decided by the power difference between the optical carrier and the OFDM signal.

Using the output of the OFDM receivers (block 300), the channel estimation matrix can be found as:

$$\underbrace{[ \begin{matrix}{c}_{X , ch 1} {a}_{11} & {c}_{Y , ch 1} {b}_{21} & {c}_{Y , ch 1} {b}_{11} & {c}_{X , ch 1} {a}_{21} \\ {c}_{Y , ch 1} {a}_{11} & {c}_{X , ch 1} {b}_{21} & {c}_{X , ch 1} {b}_{11} & {c}_{Y , ch 1} {a}_{21} \\ {c}_{X , ch 2} {a}_{12} & {c}_{Y , ch 2} {b}_{22} & {c}_{Y , ch 2} {b}_{12} & {c}_{X , ch 2} {a}_{22} \\ {c}_{Y , ch 2} {a}_{12} & {c}_{X , ch 2} {b}_{22} & {c}_{X , ch 2} {b}_{12} & {c}_{Y , ch 2} {a}_{22}\end{matrix} ]}_{PolMux channel estimation matrix} \times \underbrace{[ \begin{matrix}{X}_{i} \\ {X}_{n - i + 1} \\ {Y}_{i} \\ {Y}_{n - i + 1}\end{matrix} ]}_{Tx signals} = \underbrace{[ \begin{matrix}{X}_{i}^{′} \\ {X}_{n - i + 1}^{′} \\ {Y}_{i}^{′} \\ {Y}_{n - i + 1}^{′}\end{matrix} ]}_{Re signals}$$

The PolDeMux (block 405) can be realized by finding the inverse matrix of the PolMux channel estimation matrix (block 403) and multiplying it with the received signals, so that

$${\underbrace{[ \begin{matrix}{c}_{X , ch 1} {a}_{11} & {c}_{Y , ch 1} {b}_{21} & {c}_{Y , ch 1} {b}_{11} & {c}_{X , ch 1} {a}_{21} \\ {c}_{Y , ch 1} {a}_{11} & {c}_{X , ch 1} {b}_{21} & {c}_{X , ch 1} {b}_{11} & {c}_{Y , ch 1} {a}_{21} \\ {c}_{X , ch 2} {a}_{12} & {c}_{Y , ch 2} {b}_{22} & {c}_{Y , ch 2} {b}_{12} & {c}_{X , ch 2} {a}_{22} \\ {c}_{Y , ch 2} {a}_{12} & {c}_{X , ch 2} {b}_{22} & {c}_{X , ch 2} {b}_{12} & {c}_{Y , ch 2} {a}_{22}\end{matrix} ]}_{PolDeMux matrix}}^{- 1} \times \underbrace{[ \begin{matrix}{X}_{i}^{′} \\ {X}_{n - i + 1}^{′} \\ {Y}_{i}^{′} \\ {Y}_{n - i + 1}^{′}\end{matrix} ]}_{Re signals} = \underbrace{[ \begin{matrix}{X}_{i} \\ {X}_{n - i + 1} \\ {Y}_{i} \\ {Y}_{n - i + 1}\end{matrix} ]}_{Tx signals}$$

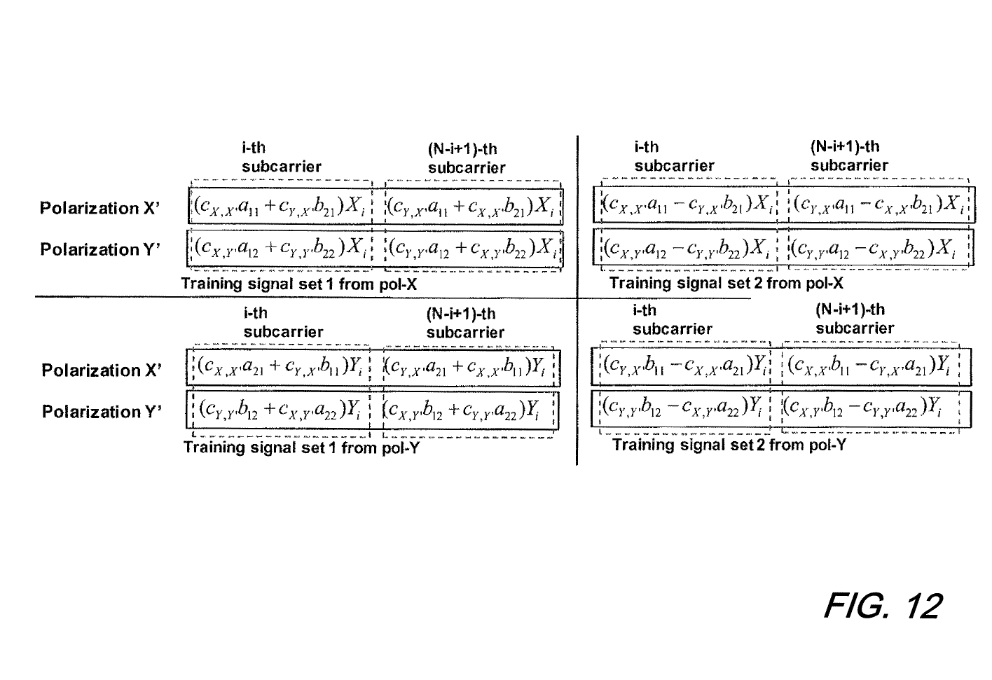

For training option 2 (block 402), the channel estimation need to be done jointly with both set 1 and set 2. The output of the OFDM receiver (block 300) can be expressed as shown in FIG. 12. As can now be readily appreciated, both PolMux channel estimation matrix and PolDeMux matrix can be found (block 404).

Significantly, both Dual-PolMux-Carriers transmitter (block 100) and the MIMO PolDeMux receiver (400) enable POLMUX-OFDM transmission using direct-detection. Advantageously, the transmitter constructed according to the present disclosure can generate the POLMUX-OFDM signal with two carriers at both sides of the signal on two orthogonal polarizations. These dual-Polmux-carriers can always provide feasible carriers at the receiver side with any state of polarizations. Similarly, a MIMO PolDeMux receiver constructed according the present disclosure may utilize the unique dual-carriers feature of the transmitter to recover the POLMUX-OFDM signals with specifically designed training signal patterns and the channel estimation algorithms.

In a transmission system constructed according to our inventive teachings, POLMUX-OFDM signals are generated by a Dual-POLMUX-carriers transmitter. At the receiver side of the transmission system, the POLMUX-OFDM signals are split with the PBS and the two outputs would be detected directly by two photodiodes. The OFDM data are recovered by the MIMO PolDeMux receiver.

At this point, while we have discussed and described the invention using some specific examples, those skilled in the art will recognize that our teachings are not so limited. Accordingly, the invention should be only limited by the scope of the claims attached hereto.

1. A polarization-multiplexing, orthogonal frequency division multiplexing transmission system (POLMUX) comprising:
a dual-POLMUX-Carriers transmitter;
a multiple-input multiple-output (MIMO) polarization demultiplexing (POL-DEMUX) receiver; and
an optical span connecting the transmitter the receiver;
wherein said MIMO POL-DEMUX receiver is a direct-detection receiver.

2. The transmission system of claim 1 wherein said transmitter further comprises:
means for generating two carriers by Intensity Modulation (IM) and carrier suppression.

3. The transmission system of claim 2 wherein said transmitter further comprises:
means for separating the two carriers.

4. The transmission system of claim 3 wherein said transmitter further comprises:
means for generating a single polarization optical orthogonal frequency division multiplexed signal.

5. The transmission system of claim 4 wherein said transmitter further comprises:
means for generating a POLMUX OFDM signal.

6. The transmission system of claim 5 wherein said transmitter further comprises:
means for generating a single sideband signal.
